(19) United States
(12) Patent Application Publication
(10) Pub. No.: US 2013/0036212 A1
(43) Pub. Date: Feb. 7, 2013

(54) BACKUP, RESTORE, AND/OR REPLICATION OF CONFIGURATION SETTINGS IN A STORAGE AREA NETWORK ENVIRONMENT USING A MANAGEMENT INTERFACE

(71) Applicants: Mahmoud K. Jibbe, Wichita, KS (US); Dhishankar Sengupta, Bangalore (IN); Krishanu Dhar, Bangalore (IN)

(72) Inventors: Mahmoud K. Jibbe, Wichita, KS (US); Dhishankar Sengupta, Bangalore (IN); Krishanu Dhar, Bangalore (IN)

(21) Appl. No.: 13/195,980

(22) Filed: Aug. 2, 2011

(51) Int. Cl. G06F 15/173

(52) U.S. Cl. 709/223

(57) ABSTRACT

A method for backing up components in a mixed vendor network using a common administration computer, comprising the steps of (A) sending a plurality of first requests to a plurality of components of a first network, (B) storing responses to the first requests in the common administration computer and (C) sending a plurality of second requests to a plurality of components in a second network in response to the stored plurality of first requests. The first network comprises components from a first manufacturer. The second network comprises components from a second manufacturer. The second network replicates the first network in response to the plurality of second requests.

### FIELD OF THE INVENTION

The present invention relates to data storage generally and, more particularly, to a method and/or apparatus to backup, restore, and/or replicate configuration settings in a storage area network environment using a management interface.

### BACKGROUND OF THE INVENTION

Organizations shipping and installing storage products have shown concern towards easy management and/or provisioning of installed storage devices. Along with manufacturing hardware and associated management software, vendors often provide a storage management interface (SMI) agent developed based on Storage Network Industry Association (SNIA) standards. SNIA promotes the use of a SMI to allow management of devices from different vendors easy and affordable. The concept of SMI overcomes interoperability of devices from different vendors.

Conventional solutions make use of Application Programming Interfaces (APIs) available from each vendor. Complications involved with such a solution involve the interoperability with different vendor devices. Each vendor tends to implement a separate management API. Separate interfaces make it difficult for a storage administrator to bring a new device into an existing site because the solution might not have adequate support for the APIs provided by the new device. Even though the new device may be cost effective to the organization, and have better performance compared to installed devices, the rigidness of such a solution sometimes deters administrators from using the new device.

It would be desirable to implement a data storage management system that may communicate with all devices in a storage area network (SAN) and/or have the capability to re-build a SAN without manual intervention once new hardware is setup.

### SUMMARY OF THE INVENTION

A method for backing up components in a mixed vendor network using a common administration computer, comprising the steps of (A) sending a plurality of first requests to a plurality of components of a first network, (B) storing responses to the first requests in the common administration computer and (C) sending a plurality of second requests to a plurality of components in a second network in response to the stored plurality of first requests. The first network comprises components from a first manufacturer. The second network comprises components from a second manufacturer. The second network replicates the first network in response to the plurality of second requests.

The objects, features and advantages of the present invention include providing a storage management solution that may (i) allow easy migration of configuration/data from a network of a first manufacturer to a network of a second manufacturer where the hardware of the second manufacturer is supported by SMI, (ii) be applicable to a network attached storage (NAS) or any other environment that conforms to SMIS standards, (iii) enable the replication of the configuration settings from a NAS to a SAN system to allow a customer to migrate from a NAS setup to a block array based on changes in the application environment, (iv) incorporate a process for starting with a clean configuration on the setup to be used for the restoration, (v) use the SMIS standard to trigger a clean configuration on each of the components before the restoration actually happens, (vi) allow users/administrators to use SMIS standards to create back up objects and/or restoration objects regardless of vendor mismatches and/or other mismatches on both of the setups to be backed up and/or the setup on which the restoration is to be installed, (vii) be extended to include backing up data by creating snapshots on the live data and/or migrating the data to the new configuration, and/or (viii) provide easy maintenance of the code since the structures and/or Extensible Markup Language (XML) calls in the code may be similar for many components regardless of the source vendor.

### BRIEF DESCRIPTION OF THE DRAWINGS

These and other objects, features and advantages of the present invention will be apparent from the following detailed description and the appended claims and drawings in which:

FIG. 1 is a block diagram of a general operation of the present invention;

FIG. 2 is a diagram of a plugin of the present invention;

FIG. 3 is a flow diagram of a general operation of the present invention;

FIG. 4 is a diagram of an example of the responses received; and

FIGS. 5a and 5b are a flow diagram of a general operation of the present invention.

### DETAILED DESCRIPTION OF THE PREFERRED EMBODIMENTS

The present invention may use one or more standard based SMI agents provided by different vendors to implement backup and/or recovery operations. The system may allow a backup and/or restore of configuration settings for each component in the SAN using SMIS. The system may also replicate the configuration on clean (e.g., new) setups with the same and/or similar components. Such backup, restoration, and/or replication may be done from a variety of vendor storage products from a first vendor to a variety of vendor storage products from a second vendor, where the SMIS may be used to manage the storage products.

Consider an example of a two array system. One array may be implemented with components from a first vendor and another array may be implemented with components from a second vendor. The second array may implement a new array, perhaps with new premium features not available or the first array. The following steps may be used to implement a transition.

1. A user may use an SMIS interface to collect the metadata DATA structure (e.g., Array Profile, Switch Profile, Host Profile, etc.) from the existing array system.

2. The user may use an SMIS interface to pass the collected DATA structure to a new array system to (a) create a backup of the system, (b) restore the configuration, and/or (c) replicate the array system.

Such an objective may be extended from a variety first arrays to a variety of second arrays that the SMIS interface may manage. The backup and/or restore process may also extend to various components, such as hosts, switches, HBAs and/or any other components that conform to SMIS.

The invention may make use of the SMI providers distributed by each vendor to replace faulty hardware with new hardware from a different vendor. The new hardware may be interoperable with other devices participating in the SAN to be handled without modifying the tool to add support for the new hardware. The interoperability between different devices may result in a unified management solution. The invention may prove to have better request and/or response time by using the CIM model. The invention may capture details of a number of devices participating on the SAN independently of the particular hardware and/or data transfer protocols implemented.

In one example, the present invention may be used to implement a disaster recovery solution to communicate with APIs from different vendor devices to retrieve information and/or perform management oriented operations. The invention may be interoperable with the APIs provided by various vendors. The present invention may overcome issues arising from dependency on vendor specific APIs.

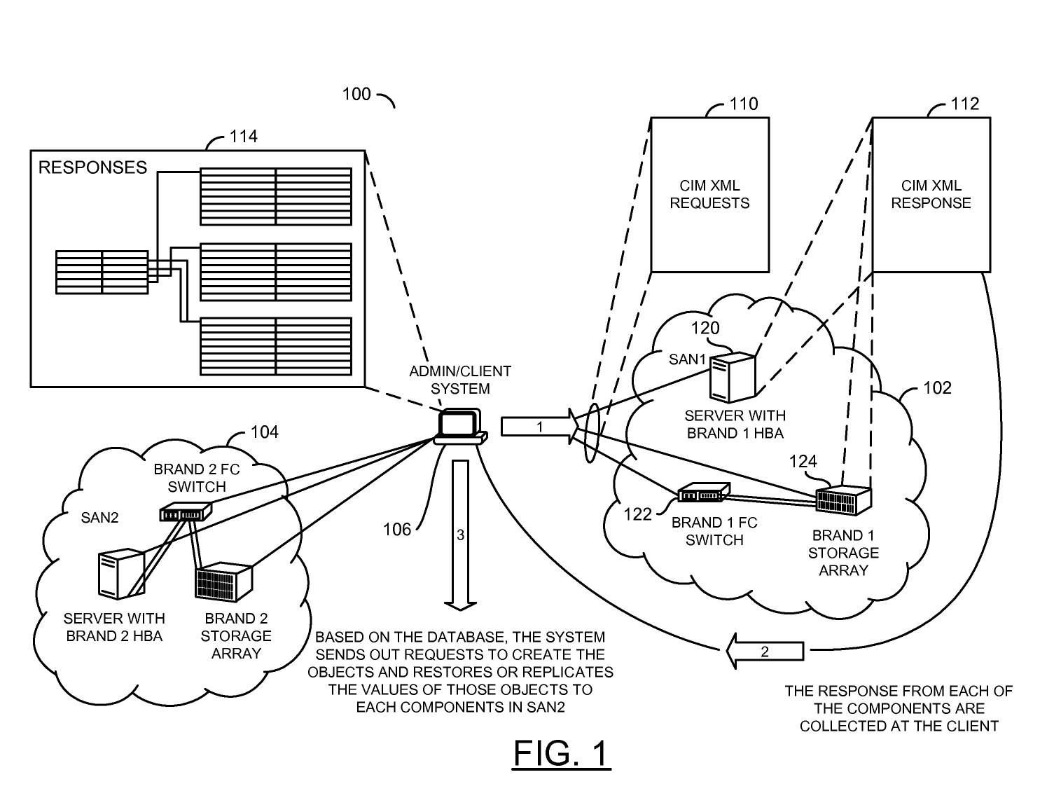

Referring to FIG. 1, a block diagram of a system 100 is shown in accordance with a preferred embodiment of the present invention. The system 100 generally comprises a block (or circuit) 102 and a block (or circuit) 104, and a block (or circuit) 106. The block 102 may be implemented as a first network, such as a storage area network (SAN). The block 104 may be implemented as a second network, such as a storage area network. The block 106 may be implemented as an administration/client interface block. The system 100 may also include a number of requests 110, a number of responses 112 and a number of responses 114. The responses 112 include responses from each of the components in the network 102. The responses 112 may be collected and stored by the interface block 106. In one example, the responses may be stored in a relational database 114. Based on the database, the system 100 may send requests to create the objects and/or restore objects needed to replicate the values of the first network and the second network 104.

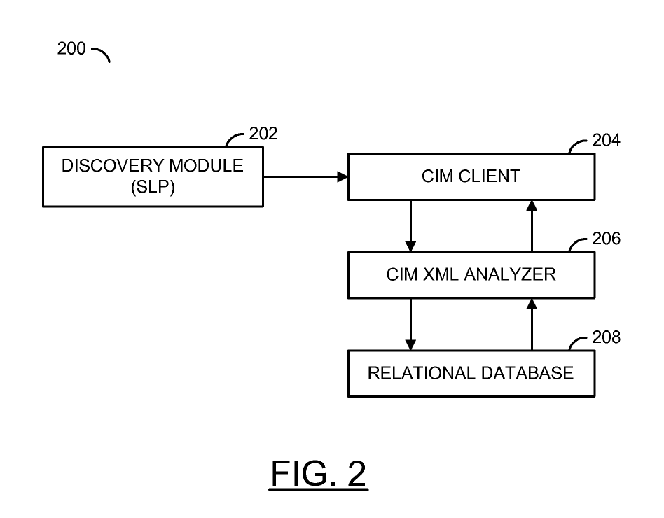

The system 100 may provide a software stack (to be described in more detail in connection with FIG. 2) that may back up the configuration on devices participating in a SAN. Upon failure of a site (e.g., the network 102) and/or a device in a site, the system 100 may replicate the same configuration that existed on the previous site/device 102 on the new site/device 104. In one example, the system 100 may be based on SNIA standards using the SMI providers developed by each of the device vendors. However, the particular standard used may be varied to meet the design criteria of a particular implementation. Since the SMI providers are built on a standard CIM model that all devices seek compliance to, the interoperability factor between the individual devices may be overcome. The system 100 may allow the development of a solution comprising different vendor products, enhanced request/response time and/or a cost effective implementation.

The SAN 102 may include one or more servers 120 (e.g., physical servers hosting one or more operating systems (OS) and/or ESX servers with guest OSes), one or more fiber channel switches 122, a host bus adapter (HBA) in the servers 120, a storage array 124 connected to the switch 122, and a management box. The server 120 may host the backup and/or recovery plugin.

The system 100 may backup certain aspects of the network 102 and/or the network 104. For example, the network 102 may include (i) FS/Partitions, (ii) Registry Settings (if applicable), (iii) Virtual Machines and/or settings (if applicable), and (iv) etc. The HBA may include (i) driver settings, (ii) FW/Driver Versions, (iii) LUN masking, (iv) etc. The switch 122 may include a configuration database that includes one or more of (i) zoning, (ii) VSAN, (iii) switch speed, port speed, (iv) port settings, (v) switch setting, and/or (vi) etc. A storage array may include (i) LUNs <->Raid Levels, (ii)) snapshots, mirrors, volume copies—premium features sets at the array, (iii) configuration database, (iv) cache settings, (v) battery setting, and (vi) etc. The system 100 may provide restore options to create the backed up components and/or corresponding objects on a new setup. The new setup may be similar (or different) in terms of vendor components and/or the same setup.

The devices in the SAN 102 may have a SMI provider configured to broadcast CIM services to facilitate discovery. Zones on the switches 122 may be created with aliases that follow a specific nomenclature (e.g., Host1HBA1Port0, Host1HBA1Port1, etc., Zone1, zone2, etc., zoneset1, zoneset2, etc.). The plugin may or may not be responsible for backing up and/or restoring the user data. A user may ensure that the components to be restored have a clear configuration.

Referring to FIG. 2, an example of a software stack 200 is shown. The software stack 200 may include a block (or module) 202, a block (or module) 204, a block (or module) 206 and a block (or module) 208. The module 202 may be implemented as a discovery module. The module 204 may be implemented as a CIM client. The module 206 may be implemented as a CIM XML analyzer. The module 208 may be implemented as a relational database. In one example, the software stack 200 may be implemented as a plugin. In one example, the software stack 200 may operate in three stages, a discovery phase, a backup phase and a restoration phase.

The following components may be defined (i) Plugin Components (e.g., Software Stack), (ii) an SLP (Service Locator Protocol) module that queries the network using a specific template to discover the various CIM services that get advertised, (iii) a CIM client (e.g., built using SMI 1.5 standards (or other SMI revisions) that have the capability to issue CIM-XML commands), (iv) the CIM XML analyzer 206 (e.g., module may have the capability to strip the data from the XML responses received and store it in a relational database) and/or (v) the relational database 208 that may store values retrieved from multiple hosts, fabrics and/or storage arrays in tables in a format that may be accessed and/or retrieved easily without bogging down the host machine (e.g., MySQL).

The software stack 200 may be configured to operate with a CIM Model of the SMI providers on the various devices in SAN 102 and/or the SAN 104. The software stack 200 may be installed on the management server 106. When a user initiates a backup of the configuration, the discovery module 202 may be initiated from a graphical user interface (GUI) or command line interface (CLI) of the plugin software stack 200. The stack 200 may discover devices in the subnet by sending queries to the network searching for CIM Services with particular attributes. For example, a query may retrieve the following information from the network:
Service Type (e.g., CIM Service, etc.)
Service Access Points (e.g., protocols and ports, etc.)
Service Attributes (e.g., namespaces, credentials, etc.)

Using the above details as an example, the CIM client 204 may login to a device and perform additional CIM operations to retrieve configuration details.

The following list provides examples of URLs of the services available on the network when an SLP query is issued to discover services in a network:
service:wbem:http://172.23.9.152:5988,65535
service:wbem:http://[2620:0:850:fff2:20c:29ff:feaf:76d9]:5988,65535
service:wbem:http://[fe80::20c:29ff:feaf:76d9]:5988,65535
service:wbem:https://172.23.9.152:5989,65535
service:wbem:https://[2620:0:850:fff2:20c:29ff:feaf:76d9]:5989,65 535
service:wbem:https://[fe80::20c:29ff:feaf:76d9]:5989,65535
service:wbem:https://weston.localdomain:5989,405
service:wbem:https://ausvm01.ks.lsil.com:5989,510

The following list provides an example of attributes retrieved after querying the wbem service of an array: [root@ rhe14i386 bin] #./slptool findattrs service:wbem:http://172.23.9.152:5988 (template-url-syntax=http://172.23.9.152:5988),(service-id=PG:1263315022656-127-0-0-1),(service-hi-name=Pegasus),(service-hi-description=Pegasus LSI CIM Server Version 2.9.1),(template-type=wbem),(template-version=1.0),(template-description=This template describes the attributes used for advertising Pegasus CIM Servers.),(InteropSchemaNamespace=interop),(FunctionalProfilesSup ported=Basic Read,Basic Write, Schema Manipulation, Instance Manipulation,Association Traversal,Query Execution,Qualifier Declaration,Indications),(MultipleOperationsSupported=FALSE),(Aut henticationMechanismsSupported=Basic), (AuthenticationMechanismDes criptions=Basic), (CommunicationMechanism=CIM-XML), (ProtocolVersion=1.0) (Namespace=root/PG_Internal, interop, ro ot/cimv2, root, root/LsiArray13), (RegisteredProfilesSupported=SNIA: Server, SNIA:Array:Device Credentials, SNIA:Array:Software Update, DMTF:Physical Asset, SNIA:Array:Job Control,SNIA:Array:Generic Initiator Port,SNIA:Array:Physical Asset, SNIA:Array:Disk Sparing, SNIA:Array:Erasure, SNIA:Array:Storage Server Asymmetry, SNIA:Array:Software Inventory, SNIA:Array, SNIA:Array:Proxy Server Management,DMTF:Indication:Profile Registration, SNIA:Array:Access Points, SNIA:Array:Multiple Computer System, SNIA:Array:Block Services, SNIA:Array:Copy Services,SNIA:Array:Disk Drive Lite, SNIA:Array:Extent Composition,DMTF:Indication,DMTF:Physical Asset:Array,SNIA:Array:Masking and Mapping,DMTF:Software Update:Array, SNIA:Array:Indications, SNIA: Server:Indication, SNIA:A rray:Block Server Performance,DMTF:Software Update, SNIA: Profile Registration,SNIA:Server:Software,SNIA:SMI-S,SNIA:Array:Generic Target Ports,SNIA:Array:Storage Enclosure)

Similarly the attributes for the other components (e.g., switch, HBA, server, etc. may also be retrieved). The information collected may be used to define information for a master table. An example of a master table in a general format stored in the relational database 208 is shown in the following TABLE 1:

TABLE 1

| Component | Type |
|---|---|
| Server | Dell2950 |
| HBA | Emu12002 |
| Switch | FC: Brocade5000 |
| Storage | LSI |
| Enclosure | NA |

A second phase may build a configuration database (e.g., an initial backup operation). The plugin 200 may have the CIM client 204 built in (e.g., developed according to SMI 1.5 standards). The CIM client 204 may have the capability to issue CIM-XML requests 110 to the CIM services discovered in the discovery phase.

To retrieve the configuration details on the storage array 102, the client 204 may perform CIM operations on two or more classes of the following profiles. First, the client may retrieve details of the physical objects in the storage array (e.g., storage array details, drives, controllers, trays, ESMs, battery, host ports and drive ports) by enumerating appropriate classes from the storage array profile and/or a sub-profiles (e.g., disk drive, Physical Package, battery profile, FC Initiator and Target Port, and Disk Sparing respectively).

Next, the client 204 may then perform another set of enumeration and associated operations to retrieve the logical objects from the storage array 102 (e.g., storage pools, storage volumes, storage partitions, LUN mappings, snapshots, volume copies, remote volume mirrors, premium features, and Hot Spares, etc.) by enumerating appropriate classes in the storage array profiles and/or sub-profiles (e.g., Storage Array Profile, Block Services Profile, LUN Masking and Mapping Profile, Copy Services Profile, Disk Sparing Profile, etc.).

An example of a cim_computersystem class is shown below. The class definition listed may be same for all providers (e.g., storage array, switch and host). The vendor provider may populate the properties with a value(s) appropriate to the product.

class CIM_ComputerSystem : CIM_System
{
string IdentifyingDescriptions[ ];
string OtherIdentifyingInfo[ ];
string Roles[ ];
string PrimaryOwnerContact;
string PrimaryOwnerName;
string Name;
string CreationClassName;
string ElementName;
string Description;
string Caption;
string InstanceID;
datetime InstallDate;
uint16 OperationalStatus[ ];
string StatusDescriptions[ ];
string Status;
uint16 HealthState;
uint16 EnabledState;
string OtherEnabledState;
uint16 RequestedState;
uint16 EnabledDefault;
datetime TimeOfLastStateChange;
string NameFormat;
uint16 Dedicated[ ];
string OtherDedicatedDescriptions[ ];
uint16 ResetCapability;
uint16 PowerManagementCapabilities[ ];
};

To retrieve the configuration details for a host, the client 204 may perform the following operations to retrieve the configuration details. With respect to the physical objects in the host (e.g., HBA, Ports and Disks), the client 204 may perform enumeration operation on the classes in the FC HBA, Storage HBA and Host Discovered Resources Profiles. The logical configuration entities (e.g., Partition information, Persistent binding, logical storage resources) available through the OS and/or multipathing are retrieved by performing CIM operations on appropriate classes of the following profiles Disk Partition Profile, Storage HBA Profile, Host Discovered Resources Profile and SCSI Multipath Management Subprofile.

To retrieve the configuration details on the Fabric, the client 204 performs a series of CIM Operations on the classes of the following Profiles. The client 204 uses the following profiles to retrieve info about the physical entities of the switch (e.g., Switch details and Ports, Fabric profile, Switch profile, FDMI Subprofile, etc.). The logical entities (e.g., the configuration on the switch and/or zoning information) are retrieved by performing CIM Operations on the classes in the following profiles: Zone Control Subprofile, Enhanced Zone Control Subprofile, FDMI Subprofile and Fabric View Subprofile.

The data retrieved via the CIM Operations may be in the form of CIM XML responses stripped by the CIM XML analyzer 206 to obtain the raw data stored in the inbuilt relational database of the plugin 200. This creates a backup of the initial configuration in the database.

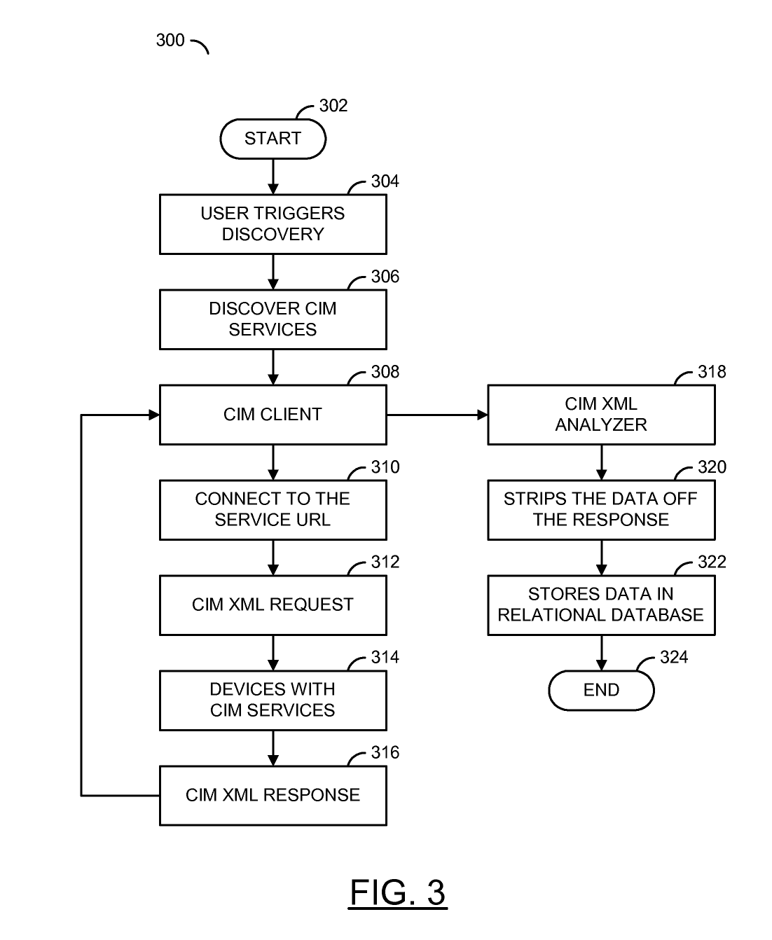

Referring to FIG. 3, a flow chart of a method 300 is shown. The method 300 illustrates an example of discovering a device and subsequently querying it to retrieve configuration information and storing the data in the database. The method 300 generally comprises a step (or state) 302, a step (or state) 304, a step (or state) 306, a step (or state) 308, a step (or state) 310, a step (or state) 312, a step (or state) 314, a step (or state) 316, a step (or state) 318, a step (or state) 320, a step (or state) 322, a step (or state) 324. The step 304 may allow a user to treat a discovery. The step 306 may provide discovery of CIM services. The step 308 may provide CIM client services. The state 310 may connect to the service URL. The state 312 may perform a CIM XML request. The state 314 may discover devices with CIM services. The state 316 may provide CIM XML responses. The state 318 may provide CIM XML analyzer. The state 320 may strike the data from the responses. The state 322 may store data in the relational database. The state 324 may be an end state. The state 302 may be a start state.

Sample child tables may be implemented similar to the following examples. A particular implementation may decide which particular additional details are populated in the tables.

CHILD TABLE 1

| Component Type: Array | value |
|---|---|
| Vendor | LSI |
| Model | 49xx |
| VolumeGroup | 2 |
| Raid Level for VG 1 | 6 |
| Raid Level for VG 2 | 1 |
| Capacity of VG1 | 5368709120 Bytes |
| Capacity of VG2 | 3617335060 Bytes |
| No of Volumes in VG1 | 10 |
| Capacity of Volume1 in | xxx bytes/Host2 |
| VG1/Mapped to Host | |
| Capacity of Volume2 in | xxx bytes/Host1 |
| VG1/Mapped to Host | |
| . . . | |
| No of volumes in VG2 | 10 |
| Capacity of Volume1 in | xx bytes/Host1 |
| VG2/Mapped to Host | |
| Capacity of Volume2 in | xx bytes/Host2 |
| VG2/Mapped to Host | |
| . . . | |
| No of Host Groups | 1 |
| No of Hosts in Host Group 1 | 2 |
| Host1 Type | FC |
| Host2 Type | FC |
| Host1 Interface Type | FC |
| Host2 Interface Type | FC |
| Settings (Array Specific | Refer Table X |
| Settings) | |
| CFW | 07.70.38.00 |
| NVSRAM | N49XX-770834-409 |

CHILD TABLE 2

| Component Type: FC Switch | Value |
|---|---|
| Vendor | Brocade |
| Model | 5000 |
| Version | 6.4.0 |
| Alias | |
| Host1HBA1Port0 | 10:00:00:00:c9:6f:d8:0e |
| Host1HBA1Port1 | 10:00:00:00:c9:6f:D8:0f |
| Host2HBA1Port0 | 10:00:00:00:c9:71:7b:c7 |
| Host2HBA1Port1 | 10:00:00:00:c9:71:7b:c6 |
| Array1HostPortA | 20:14:00:a0:b8:29:ec:1c |
| Array1HostPortB | 20:15:00:a0:b8:29:ec:1c |
| Array2HostPortA | 20:22:00:80:35:17:b3:6e |
| Array2HostPortB | 20:43:00:80:35:17:b3:6e |
| . . . | |
| Zones | |
| Zone1: | Host1HBA1Port0, Array1HostPortA, |
| | Array 2HostPortA |
| Zone2: | Host1HBA1Port1, Array1HostPortB, |
| | Array 2HostPortB |
| . . . | |
| . . . | |
| Zonesets | |
| zoneset1 | zone1, zone2, . . . |
| Zoneset2 | zone6, zone8, . . . |
| Active Zoneset | zoneset1 |
| Settings (Switch Specific | Refer Table Y |
| Settings) | |

Similarly for the server/host also the following details can be captured.

TABLE 3

Server/Host
Server Model
OS
No of Partitions
Files Systems
Virtual Machines (if applicable)
Registry Settings (if applicable)
HBA Vendor/Model
HBA FW/driver
HBA: LUN Masking
HBA Settings (Driver Settings—
Timeouts and other port settings
etc)

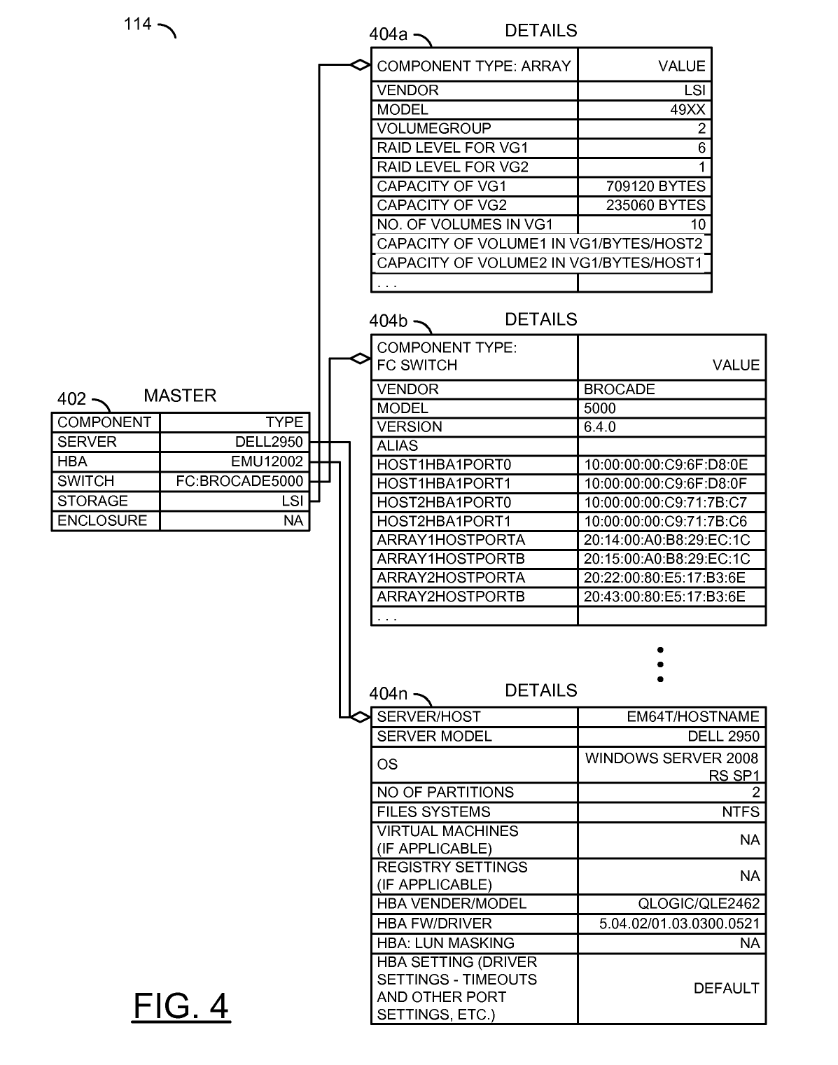

Referring to FIG. 4, a diagram of the responses 114 is shown. The responses 114 may be configured as a relational database, a number of look-up tables, or other appropriate configuration to store data. The responses 114 generally comprise a block (or section) 402 and a number of blocks (or sections) 404a-404n. In one example, the block 402 may be implemented as a master table. In one example, the master table 402 may be configured as a look-up table, or relational database, etc. For example, when a request for a device in the left column is received, a response presenting the information in the right column may be sent. For example, if the request for a “SERVER” is received, the response of “DELL2950” may be presented. The items in the right column represent examples of the types of devices that may be implemented. The particular type of devices presented in the columns may be varied to meet the design criteria of a particular implementation.

The blocks 404a-404n show examples of details of a particular device from the master table 402. For example, the block 404a may correspond to the “STORAGE” section of the master table 402. The table 404b may correspond to the column labeled “SWITCH” in the master table 402. The table labeled 404n may correspond to the column labeled “SERVER” or “HBA” in the master table 402. The table 404a shows particular parameters for the example of a storage device. For example, one column on the left shows the entry “MODEL”. The value on the right is shown as “49XX”. In general, each of the entries on the left column has a corresponding value on the right column. The TABLES 404b-404n provide additional details on the various components. The particular number of TABLES 404a-404n implemented may be varied to meet the design criteria of a particular implementation.

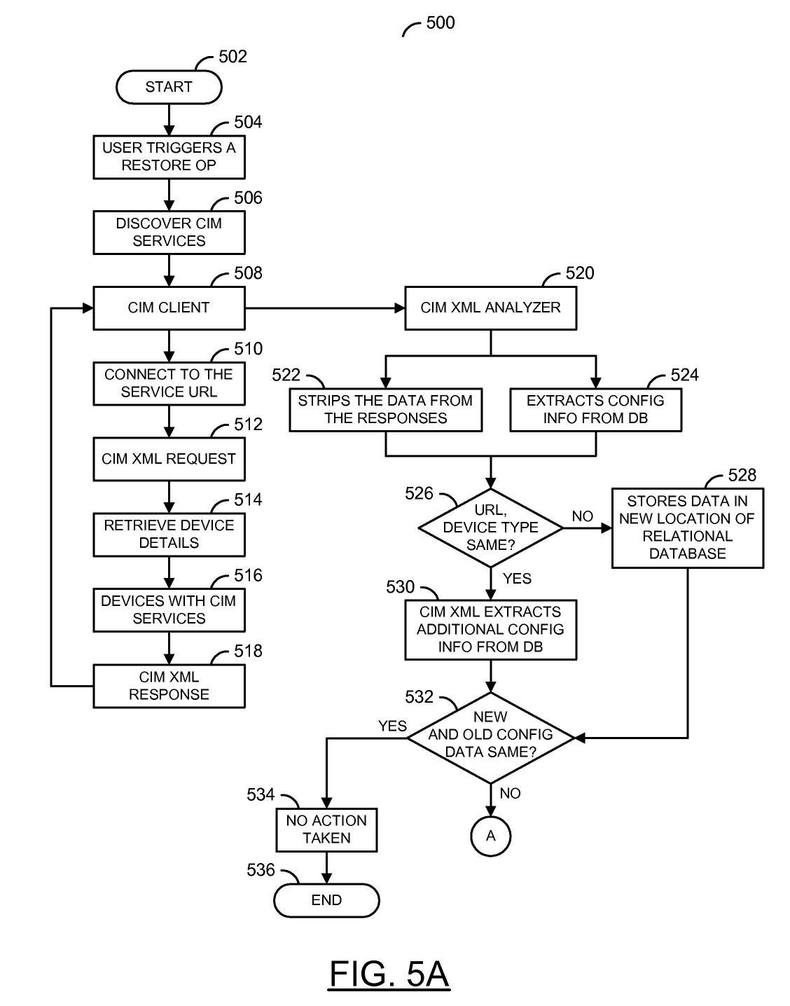

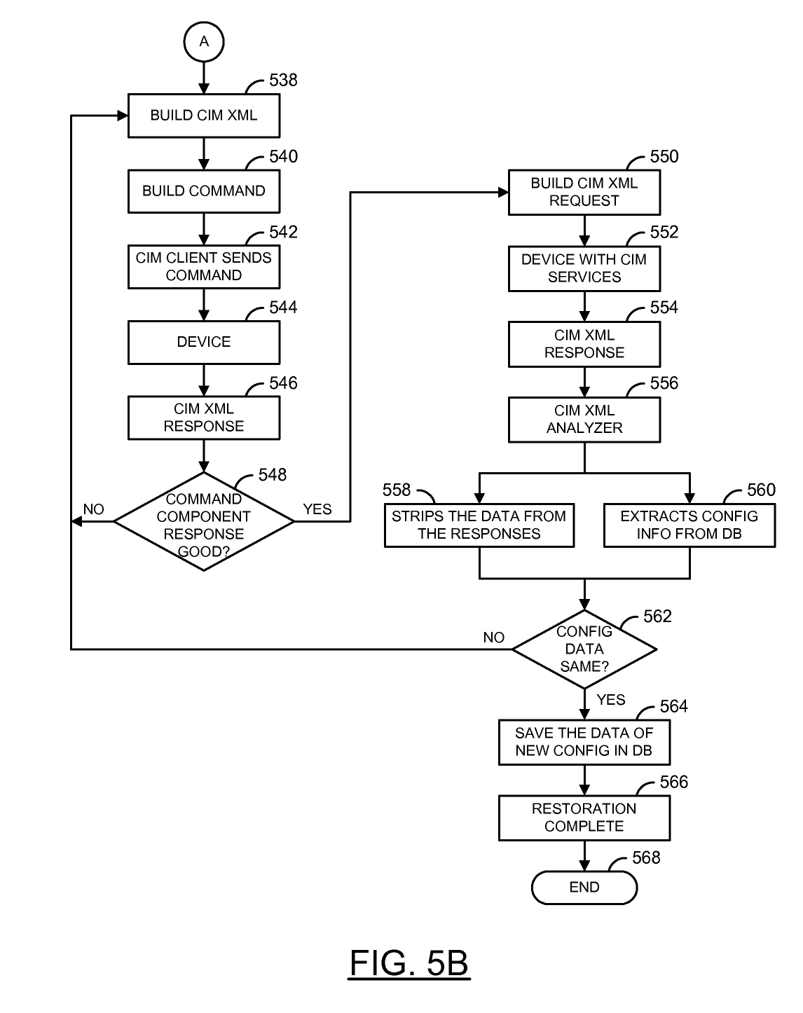

Referring to FIGS. 5A and 5B, an example of a flow diagram of a method (or process) 500 is shown. The method 500 may have a state 502 that begins the method. A state 504 may allow a user to trigger a restore operation. A state 506 may initiate a discovery of CIM services process. A state 508 may initiate control a CIM client. For example, the state 508 may call a CIM analyzer state 520. A state 510 may connect to the service URL. A state 512 may initiate a CIM XML request. A state 514 may retrieve device details. A state 516 may communicate with devices with CIM services. The state 518 may provide a CIM XML response. The states 508, 510, 512, 514, 516 and 518 may be implemented on the network to be restored. The state 520 may represent the CIM XML analyzer of FIG. 3 (e.g., 318). A state 522 may strop the data from the response. The state 524 may extract configuration information from the database. A decision state 526 may determine whether a URL and device type are the same type. If not, the method 500 may move to the state 528. The state 528 may store data in a new location of the relational database. If the state 526 determines the URL and the device type are the same, the method 500 may move to the state 530. The state 530 may implement a CIM XML extraction of additional configuration information from the database.

Next, the method 500 moves to the state 532. The state 532 may determine whether the new and old configuration are the same. If so, the method 500 moves to the state 534. The state 534 generally takes no action and moves to a state 536 that ends the method 500. If the decision state 532 determines the new and old configuration are not the same, the method 500 moves to the state 538. The state 538 builds a CIM XML file. Next, the state 540 implements a build command. Next, the state 542 implements a CIM client send command. Next, the state 544 represents the last device to be analyzed. Next, the state 546 initiates a CIM XML response. Next, a decision state 548 determines whether a command component response is good. If not, the method 500 moves back to the state 538. If so, the method 500 moves to the state 550. The state 550 builds a CIM XML request. Next, a state 552 implements a device with CIM services. Next, the state 554 implements a CIM XML response. Next, the state 556 implements a CIM XML analyzer. Next, the state 558 strips the data from the responses. In parallel, a state 560 may extract configuration information from the database. Next, the state 562 determines if the configurations are the same. If not, the method 500 moves back to the state 538. If so, the method 500 moves to the state 564. The state 564 saves the data of the new configuration in the database. Next, the state 566 issues a restoration complete command. Next, the state 568 ends the process.

In an event of a device failure, a user may trigger the restoration procedure on the plugin 200. Another discovery session may be initiated where the plugin 200 queries the subnet for new devices. The discovery phase may return the URL of the CIM service and associated profiles the device has support for that can be used for restoration work. Using the URL obtained, the CIM client 204 may log into the device and via CIM XML requests retrieves device specific information from it. The CIM XML analyzer 206 may perform two operations here a) strip the raw data off the XML and b) queries the database 208 to retrieve the initially stored device specific details. The analyzer 206 may compare the URL and device types to figure out if the device is a new hardware device. If the URL/Device Type is the same the configuration details of the devices, a mismatch may occur. The configuration with the initially stored details the CIM XML analyzer may build a CIM command to recreate the objects on the new device.

The plugin 200 may create the logical objects based on the result of the comparison. For example, for a storage array, the plugin 200 may create the volume groups, volumes, snapshots, volume copies etc on the un-configured storage array. The same process may be followed for the other components.

The plugin 200 will not normally perform any firmware, driver, or BIOS upgrades on any of the components, although such upgrades are possible. The plugin 200 normally perform a comparison and report the mismatches. A user may use information from the plugin 200 to determine whether to perform upgrade. In certain cases, an automatic upgrade may be performed.

The CIM client 204 may execute the command on the device. If the particular CIM XML response 112 indicates a success, the CIM XML request module 110 builds another request to confirm if the object creation was successful on the device. The CIM client 204 may send the CIM XML request to the device. The CIM XML analyzer 206 may perform two tasks (a) capture the CIM XML response 112 and strip the raw data off the XML and (b) queries the database to retrieve the data stored initially.

The two configurations may be compared to see if they are substantially identical. If the comparison is a success, the database 208 may be updated with the new configuration. If the comparison fails, control returns to the point where the CIM client 204 issues commands to recreate the objects. If the comparison of the URL/device type fails, a new device is normally present and the device specific details would be captured and/or stored in the database 208. Subsequently, the configuration details of the new device would be compared with the initial data. The comparison normally fails if the new device does not have any configuration. The CIM XML analyzer 206 may proceed to create the CIM XML commands to create the objects based on the initial data and/or transfer control to the CIM Client to execute the request. If the CIM XML request fails with a bad response, the process of creating the command to create the objects on the device is re-initiated.

The following is a sample of a CIM XML Request. The CIM XML Analyzer module 206 may use the requests to develop the CIM command.

<--- request begin -----
POST /cimom HTTP/1.0
HOST: beast
Content-type: application/xml; charset=“utf-8”
Content-length: 562
CIMOperation: MethodCall
CIMProtocolVersion: 1.0
CIMMethod: EnumerateClasses
CIMObject: root
<?xml version=“1.0” ?>
<CIM CIMVERSION=“2.0” DTDVERSION=“2.0”>
<MESSAGE ID=“1” PROTOCOLVERSION=“1.0”>
<SIMPLEREQ>
<IMETHODCALL NAME=“EnumerateClasses”>
<LOCALNAMESPACEPATH>
<NAMESPACE NAME=“root”></NAMESPACE>
</LOCALNAMESPACEPATH>
<IPARAMVALUE NAME=“LocalOnly”>
<VALUE>TRUE</VALUE>
</IPARAMVALUE>
<IPARAMVALUE NAME=“DeepInheritance”>
<VALUE>FALSE</VALUE>
</IPARAMVALUE>
<IPARAMVALUE NAME=“IncludeQualifiers”>
<VALUE>FALSE</VALUE>
</IPARAMVALUE>
<IPARAMVALUE NAME=“IncludeClassOrigin”>
<VALUE>TRUE</VALUE>
</IPARAMVALUE>
</IMETHODCALL>
</SIMPLEREQ>
</MESSAGE>
</CIM>
---- request end ------>

Below is a sample CIM XML response CIM XML analyzer 206 strips from the response received from the device provider.

<--- response begin ----
HTTP/1.0 200 OK
Content-type: application/xml; charset=“utf8”
Ext:
Connection: close
Cache-Control: no-cache
CIMOperation: MethodResponse
CIMProtocolVersion: 1.0
<?xml version=“1.0” ?>
<CIM CIMVERSION=“2.0” DTDVERSION=“2.0”>
<MESSAGE ID=“1” PROTOCOLVERSION=“1.0”>
<SIMPLERSP>
<IMETHODRESPONSE NAME=“EnumerateClasses”>
<IRETURNVALUE>
<CLASS NAME=“_{——}Namespace”>
<PROPERTY NAME=“Name” TYPE=“string” CLASSORIGIN=“” >
</PROPERTY>
</CLASS>
<CLASS NAME=“CIM_ManagedSystemElement”>
<PROPERTY NAME=“Caption” TYPE=“string”
CLASSORIGIN=“CIM_ManagedSystemElement” >
</PROPERTY>
<PROPERTY NAME=“Description” TYPE=“string”
....
....
</IRETURNVALUE>
</IMETHODRESPONSE>
</SIMPLERSP>
</MESSAGE>
</CIM>
---- response end ----->

These request and response samples are based on SNIA SMI standards which will used to create the components on the new configuration. The system 100 may be useful in any backup/restore environment when a user creates a system configuration similar to the backed up setup.

The functions performed by the diagrams of FIGS. 3 and 5 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. A method for backing up components in a mixed vendor network using a common administration computer, comprising the steps of:
(A) sending a plurality of first requests to a plurality of components of a first network;
(B) storing responses to said first requests in said common administration computer; and
(C) sending a plurality of second requests to a plurality of components in a second network in response to said stored plurality of first requests, wherein (i) said first network comprises components from a first manufacturer, (ii) said second network comprises components from a second manufacturer, and (iii) said second network replicates said first network in response to said plurality of second requests.

2. The method according to claim 1, wherein said administration computer is configured to run an interface.

3. The method according to claim 2, wherein said interface comprises an SMIS interface.

4. The method according to claim 2, wherein said interface operates independently of a hardware transfer protocol.

5. The method according to claim 2, wherein said interface operates independently of a data transfer protocol.

6. The method according to claim 1, wherein said first network comprises a networked attached storage (NAS) based network.

7. The method according to claim 1, wherein said second network comprises a block array based network.

8. The method according to claim 1, wherein step (C) is implemented without manual intervention.

9. The method according to claim 1, further comprising the step of:
migrating data from said first network to said second network.

10. An apparatus comprising:
a first network;
a second network; and
a management computer connected to said first network and said second network, wherein (A) said management computer is configured to (i) send a plurality of first requests to a plurality of components of said first network, (ii) store responses to said first requests and (iii) send a plurality of second requests to a plurality of components in a second network in response to said stored first plurality of first requests, and (B) (i) said first network comprises components from a first manufacturer, (ii) said second network comprises components from a second manufacturer, and (iii) said second network replicates said first network in response to said plurality of second requests.
